(19) United States
(12) Patent Application Publication
(10) Pub. No.: US 2012/0109338 A1
(43) Pub. Date: May 3, 2012

(54) METHOD FOR IMPLEMENTING AN ELECTRONICALLY TUNABLE STRUCTURE, AND ELECTRONICALLY TUNABLE STRUCTURE

(75) Inventors: Ladislau MATEKOVITS, Torino (IT); Mario OREFICE, Torino (IT); Karunanayake Pathirannahalage Asoka Priyathama ESSELLE, Sydney (AU); Michael Craig HEIMLICH, Sydney (AU)

(73) Assignees: MACQUARIE UNIVERSITY, North Ryde (AU); POLITECNICO DI TORINO, Torino (IT)

(21) Appl. No.: 13/166,389

(22) Filed: Jun. 22, 2011

(30) Foreign Application Priority Data
Jun. 22, 2010 (IT) TO2010A 000536

(51) Int. Cl. G05B 11/01

(52) U.S. Cl. 700/12

(57) ABSTRACT

A method for implementing an electronically tunable structure including: a plurality of elementary cells interacting with the same electromagnetic field; a control unit and a plurality of electronic control devices, each of which is connected to the control unit and to a respective elementary cell. The control unit provide each electronic control device with a corresponding control signal. Each electronic control device is controllable to vary a state of the corresponding elementary cell. The control unit provides control signals such to define a group of identical patterned cells formed by a respective number of adjacent elementary cells. The states of the cells define a predetermined state configuration, so that the states of the group define a periodical sequence of states.

The present invention relates to a method for implementing an electronically tunable structure, and to an electronically tunable structure. Specifically, the present invention relates to a method for implementing a periodic or quasi-periodic electronically tunable structure.

### BACKGROUND OF THE INVENTION

As it known, nowadays many tunable structures are available, which are used in many application fields. Specifically, the use of electronically tunable structures is common in the area of electromagnetics, where these structures are used for the implementation, as an example, of antennas and filters.

Generally, an electronically tunable structure is composed by a plurality of elementary cells, consisting of metallic material and typically arranged according unidimensional or bidimensional geometries, although also electronically tunable structures with non planar geometry are known.

In particular, in the case of tunable structures of periodic or quasi-periodic type, the elementary cells are commonly referred to as “unit cells”.

Any elementary cell is configured to interact with an electromagnetic field in an electronically controllable manner. Specifically, any electronically tunable structure comprises, for each elementary cell, a relevant control device, which is typically able to vary, in a stepped or continuous manner, the value of at least one electrical quantity, as, for example, the resonance frequency of the relevant elementary cell.

Given an electromagnetic wave propagating through an elementary cell, the variation of this electrical quantity of the elementary cell implies a corresponding variation of the impedance that such elementary cell represents with respect to the electromagnetic wave, as well as a corresponding variation of the propagation constant characterizing the propagation of the electromagnetic wave through this elementary cell.

As an example, the patent application WO2008/140544 describes an electronically tunable structure having bi-dimensional geometry, in which the elementary cells are formed by conducting plates, arranged on the same plane and parallel with respect to a ground plane. Each conducting plate is connected to the ground plane by means of a corresponding voltage controlled capacitor, also known as varactor, which is connected on its turn to this conducting plate and on the other side to the output of a corresponding analog-to-digital (A/D) converter, which polarizes the varactor to a respective polarization voltage. In practice, by sending suitable input signals to the A/D converters, it is possible to polarize the varactors in such a way that they introduce appropriate capacities. In other words, by sending suitable input signals to the A/D converters, it is possible to modify the reactance of the elementary cells. Consequently, assuming the presence of an electromagnetic wave incident on the electronically tunable structure, i.e. exciting the electronically tunable structure, it is possible to polarize the varactors in such a way that the elementary cells connected to them introduce suitable phase shifts on the electromagnetic wave reflected by the electronically tunable structure. Through a suitable polarization of the varactors, it is therefore possible to direct in a desired direction the reflected electromagnetic wave.

Another example of electronically tunable structure is described in the patent application US2009/0109121, where it is described an electronically tunable reflector, consisting in an array of electrodes each connected to a corresponding varactor, which allows to modulate the phase shifts introduced by the electrodes on an electromagnetic wave reflected by this electronically tunable reflector.

Other electronically tunable structures are also known, which can be excited by means of the generation of guided waves inside the electronically tunable structure, and in particular by means of generation of surface waves, as in the case described in patent U.S. Pat. No. 7,639,207.

In general, electronically tunable structures are based on the possibility of electronically modifying the interaction that each elementary cell locally has with a generic electromagnetic field exciting the tunable structure, for example by impinging on the tunable structure, or propagating along the tunable structure. For this reason, electronically tunable structures comprise control devices, as varactors and A/D converters, which, as previously mentioned, allow the variation of at least one electrical quantity associated with the elementary cells, in a discrete or continuous manner. In practice, control devices allow to modify the interaction which takes place between each elementary cell and the exciting electromagnetic field. In other words, control devices allow setting, for each elementary cell, a corresponding state, which characterizes the interaction between this elementary cell and the exciting electromagnetic field.

Electronically tunable structures have a high flexibility of use, and in fact they are widely employed as antennas, filters, tunable reflectors, etc. However, if we define in general, as response of an electronically tunable structure, any indicator of the electromagnetic behaviour of this electronically tunable structure, the determination of the responses that may be obtained with the variation of the states of the elementary cells, that is the characterization of the electronically tunable structures, may be difficult. As an example, the response of an electronically tunable structure may be alternatively a radiation pattern, or a transfer function, depending on the fact that this electronically tunable structure acts as an antenna of as a filter.

In practice, given as an example a target response and the subsequent synthesis of corresponding phase shifts that must be locally introduced on the exciting electromagnetic field to obtain such a target response, it may be difficult to implement an electronically tunable structure able to introduce these phase shifts, and therefore to actually provide the target response. In particular, the implementation may be difficult in the case of electronically tunable structures consisting of a high number of elementary cells.

In fact, the computation of the number of elementary cells and of the corresponding states that allow obtaining these phase shifts, and consequently to obtain the target response, is so computationally heavy that it is practically impossible, also in the case where the number of cells is not particularly high.

### SUMMARY OF THE INVENTION

The aim of the present invention is to provide a method of implementation of an electronically tunable structure, able to solve at least in part the inconvenients of the present state of the art.

According the present invention, a method of implementation of an electronically tunable structure, an electronically tunable structure, an electronic device, an antenna and a filter are provided, as respectively defined in claims 1, 9, 14, 16 and 17.

### BRIEF DESCRIPTION OF THE DRAWINGS

For a better understanding of this invention, in the following are described forms of implementation, as a mere non limiting example, and with reference to the enclosed drawings, where:

FIG. 1 shows a schematic perspective view of a first electronically tunable structure;

FIG. 2 shows a perspective view of a portion of the electronically tunable structure shown in FIG. 1;

FIG. 3 shows a side view of the portion shown in FIG. 2;

FIGS. 4, 5 and 7 show flow diagrams of operations according the present method;

FIGS. 6a-6c show different portions of a same table;

FIG. 8 shows a binary sequence made by states of corresponding elementary cells; and

FIG. 9 shows a schematic perspective view of a further electronically tunable structure.

### DETAILED DESCRIPTION OF THE INVENTION

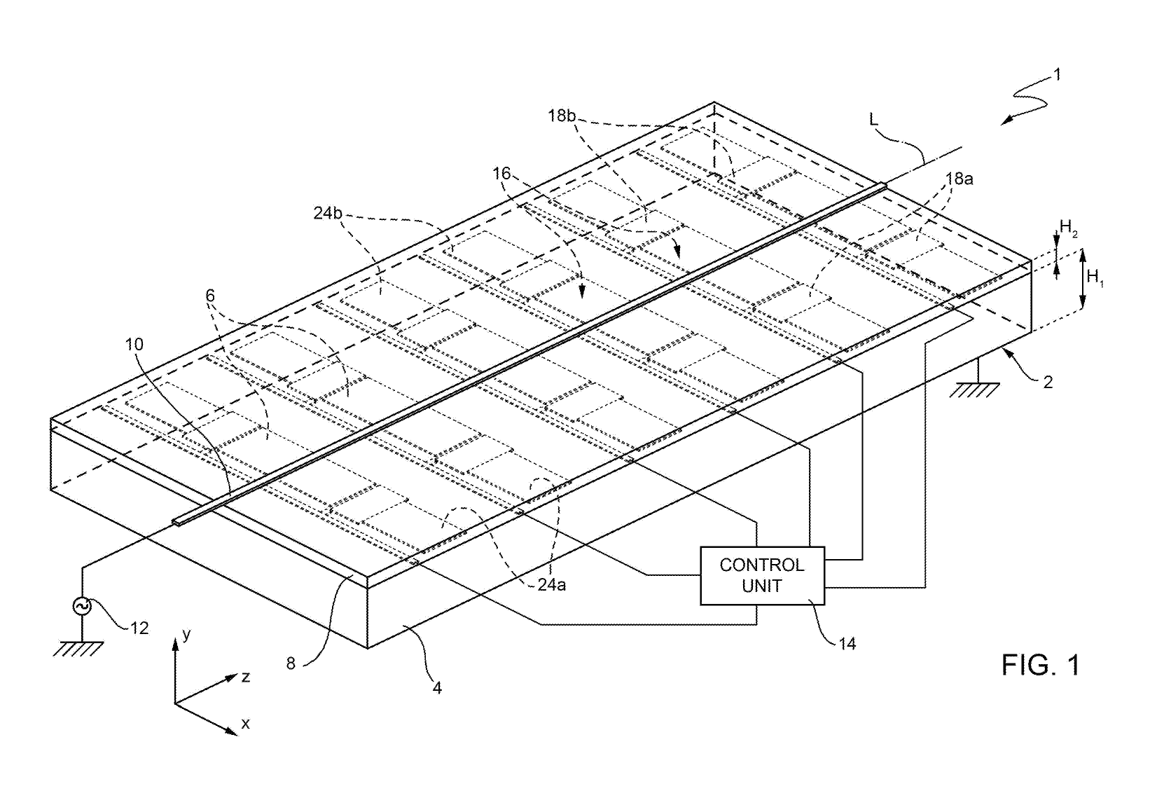

In the following, the present method is described, with particular reference, as an example, to the electronically tunable structure 1 shown in FIG. 1, which will be referred to in the following as the tunable structure 1.

Specifically, the tunable structure 1 comprises a ground plane 2, a substrate 4 and a plurality of elements of semiconducting material, which will be referred to in the following as patches 6. The substrate 4 is extended above the ground plane 2, and may be made, as an example, by gallium arsenide (GaAs), and has a thickness H₁, equal, as an example, to 100 μm. The patches 6 are extended above and in direct contact with substrate 4, and have a substantially planar geometry (with negligible thickness) and rectangular shape; moreover, the patches 6 are arranged parallel to the ground plane 2, are coplanar and aligned along a principal direction L.

The tunable structure 1 comprises also an upper layer 8, made for example by a dielectric material as silicon nitrate, and a transmission line of conducting material 10, which will be referred to as the microstrip 10. Specifically, the upper layer 8 may have a thickness H₂ equal, for example, to 2 μm, and is extended above substrate 4 and patches 6, while the microstrip 10 is extended above the upper layer 8. In particular, the microstrip 10 is parallel to the principal direction L, and therefore parallel to the ground plane 2 and to the patches 6, from which is ohmically decoupled.

Specifically, assuming that patches 6 are infinitesimally thin and introducing an orthogonal reference system x,y,z consisting of a z axis parallel to the principal direction L and to the plane of the patches 6, of an x axis orthogonal to the z axis and parallel to the plane of the patches 6, and of a y axis orthogonal to both x and z axis, the microstrip 10 is parallel to the x axis. Moreover, microstrip 10 has a width, measured along the x axis, negligible with respect to the width of the patches 6, and it is arranged in a way such that, assuming that it has an infinitesimal width, its projection on the plane defined by the patches 6 subdivides each patch 6 in two equal parts.

The tunable structure 1 comprises also a source of surface waves 12, schematically shown and coupled to the microstrip 10, and a control unit 14, which, as described in the following, is connected to the patches 6.

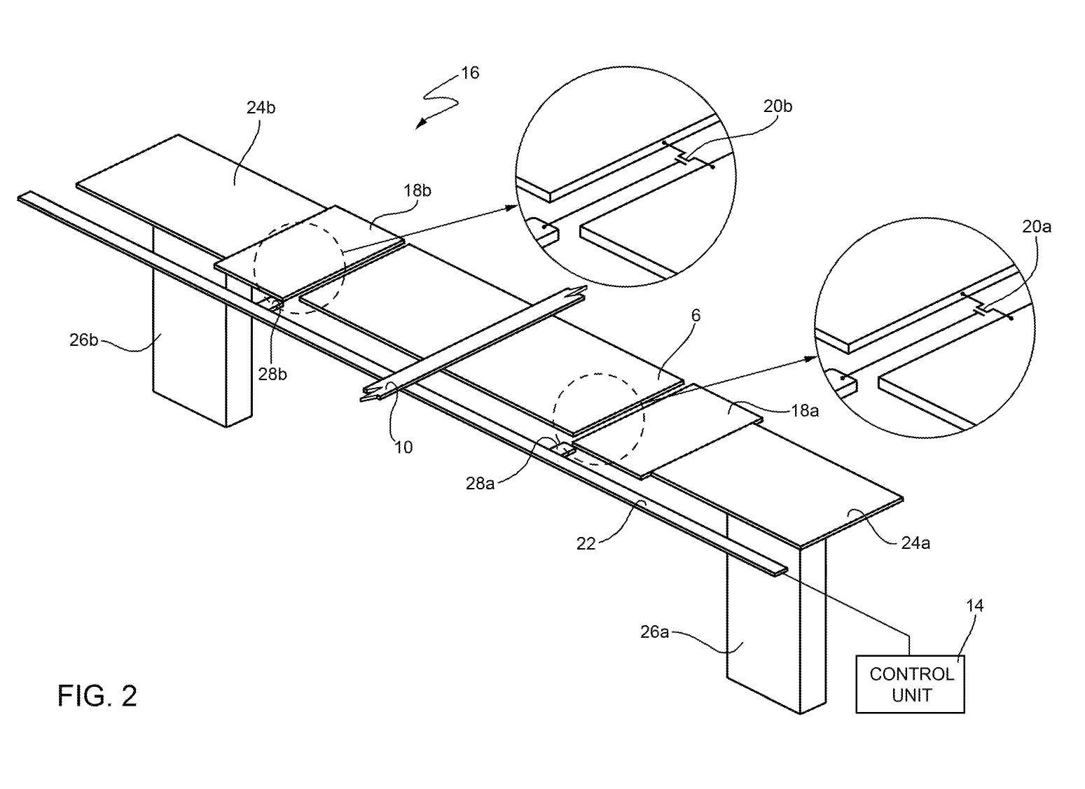

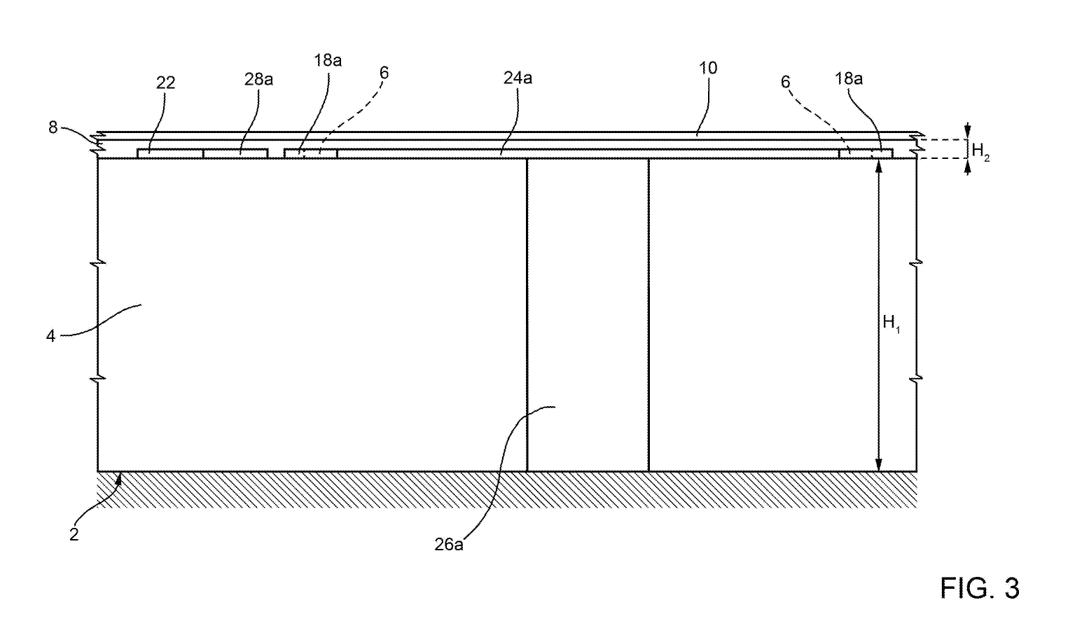

More specifically, the tunable structure 1 comprises a plurality of elementary cells 16, each of them being made by a corresponding patch 6. Moreover, as shown in more detail in FIGS. 2 and 3, each elementary cell 16 comprises, in addition to the relevant patch 6, a first and a second portion of connection, indicated respectively as 18a and 18b, which will be referred to in the following as the first and second pad 18a, 18b. Moreover, each elementary cell 16 comprises a first and a second transistor 20a, 20b (shown symbolically in FIG. 2), a control line 22, a first and a second connection element 24a, 24b, and a first and a second via 26a, 26b, these latter being shown only in FIGS. 2 and 3.

Specifically, given a generic elementary cell 16, the first and the second pad 18a, 18b have a substantially planar geometry and are extended above the substrate 4, therefore they are coplanar with the relevant patch 6; moreover, the first and the second pad 18a, 18b are arranged in a specular manner with respect to the projection of the microstrip 10 on the plane of the patch 6, and are connected to the relevant patch 6, respectively through the first and the second transistor 20a, 20b of the generic elementary cell 16.

The first and the second connection element 24a, 24b have a substantially planar geometry and are extended above the substrate 4, and therefore are coplanar with the relevant patch 6; moreover, also the first and the second connecting element 24a, 24b are arranged in a specular manner with respect to the projection of the microstrip 10 on the plane of the patches 6. The first and the second connecting element 24a, 24b are moreover in ohmic contact respectively with the first and second pad 18a, 18b of the generic elementary cell 16.

The first and the second via 26a, 26b are extended inside substrate 4, and they are arranged in a specular manner with respect to the projection of the microstrip 10 on the plane of the patches 6. Moreover, the first and second via 26a, 26b are in ohmic contact with the ground plane 2 and, respectively, with the first and the second connecting element 24a, 24b.

More specifically, the first and second transistor 20a, 20b may be field effect transistors (FET) and may be integrated inside the substrate 4. In particular, a first conduction terminal of the first transistor 20a is connected to the patch 6; a second conduction terminal of the first transistor 20a is connected to the first pad 18a, and the gate terminal of the first transistor 20a is connected to the control line 22 of the generic elementary cell 16. A first conduction terminal of the second transistor 20b is connected to the patch 6; a second conduction terminal of the second transistor 20b is connected to the second pad 18b, and the gate terminal of the second transistor 20b is connected to the control line 22.

More specifically, the control line 22 is made of conducting material and is extended above the substrate 4, perpendicularly with respect to the principal direction L. Moreover, the control line 22 defines a first and a second pad 28a, 28b, which are respectively connected to the gate terminals of the first and second transistor 20a, 20b. Again, the control line 22 is connected to the control unit 14.

From the operational point of view, the control unit 14 may provide a control signal on the control line 22 of the generic elementary cell 16. To this purpose, the control unit 14 may apply to the control line 22 a polarization voltage, which is therefore applied to the gate terminals of the first and second transistor 20a, 20b. In practice, by varying the polarization voltage, the control unit 14 may bring the first and the second transistor 20a, 20b alternatively in interdiction or conduction states, in a known way. In particular, when the first and the second transistor 20a, 20b are in conduction state, patch 6 of the generic elementary cell 16 is electrically connected to the ground plane 2, while, when the first and the second transistor 20a, 20b are in interdiction, patch 6 is floating.

Still from an operational point of view, the surface wave source 12 is able to excite one or more surface waves, which propagate along the tunable structure 1, and in particular at the interface between the substrate 4 and the upper layer 8, or at the interface between the upper layer 8 and the air above the tunable structure 1; in practice, such surface waves are modes of the tunable structure 1.

Such surface waves have local variations of their relevant propagation constants, due to the presence of patches 6. Moreover, these local variations are different depending on the fact that patches 6 are floating, or connected to the ground plane 2.

More specifically, the surface wave source 12 may be implemented in a known manner. As an example, the surface wave source 12 may be formed by a so-called surface-wave launcher, which may be coupled by a metallic grating planar lens, as described, for example, in “Planar Surface-Wave Sources and metallic Grating Lenses for Controlled Guided-Wave Propagation”, di S. Podilchak, A. Freundorfer e Y. Antar, IEEE Antennas and Wireless Propagation Letters, vol. 8, 2009. In any case, it is always possible to excite surface waves inside the tunable structure 1 in a manner different from what described before, as an example by the incidence of an electromagnetic wave on the tunable structure 1; this may occur, as an example, when the tunable structure 1 is conceived to be used as reflector, in which case the surface wave source may be missing. In the following, the present method is anyway described with particular reference to the use of the tunable structure 1 as an antenna or a filter, thus assuming that the surface wave source is actually present.

From the operating point of view, the control unit 14 is able to vary independently the state of each elementary cell 16, by sending corresponding control signals on the relevant control lines 22. In practice, considering an elementary cell 16, the state of such cell 16 is related to the fact that the patch 6 of such elementary cell 16 is connected to the ground plane 2 or is floating. Therefore, the state is an indication of the value taken from an electrical quantity associated to the considered elementary cell 16; in particular, the state is an indication of a resonance frequency of the considered elementary cell 16. Changes of state correspond in fact to variations of the geometrical shape of the considered elementary cell 16. Consequently, a change of the state of the considered elementary cell 16 implies on its turn a variation of electrical quantities characterizing the interaction between this elementary cell 16 and at least one surface wave crossing this elementary cell 16. As an example, different states are associated to different impedances introduced by this elementary cell 16 to at least one surface wave propagating along the tunable structure 1 in correspondence to patch 6 of the considered elementary cell 16, or to different propagation constants characterizing the propagation of at least one surface wave propagating along the tunable structure 1 in correspondence of patch 6 of the considered elementary cell 16.

In other words, the control unit 14 may control the phase value locally taken by a generic surface wave launched by the surface wave source 12 and propagating along the tunable structure 1. Moreover, assuming that the tunable structure 1 is formed by N elementary cells 16, and indicating the status of each elementary cell 16 alternatively with “0” or “1” according to the fact that the relevant patch 6 is connected to the ground plane 2 or it is floating, the tunable structure 1 admits 2̂N different electromagnetic configurations. In principle, any electromagnetic configuration of the tunable structure 1 may correspond to a different response of the tunable structure 1. Moreover, it is possible to express globally the states of the N elementary cells 16 of the tunable structure 1, and therefore the electromagnetic configurations of the tunable structure 1, in terms of binary sequences of N bits.

According to the present method, in order to characterize the tunable structure 1, it is possible to characterize unit cells, i.e. portions of the tunable structure 1, each of which is formed by a corresponding number Mᵢ of adjacent elementary cells, with Mᵢ<N.

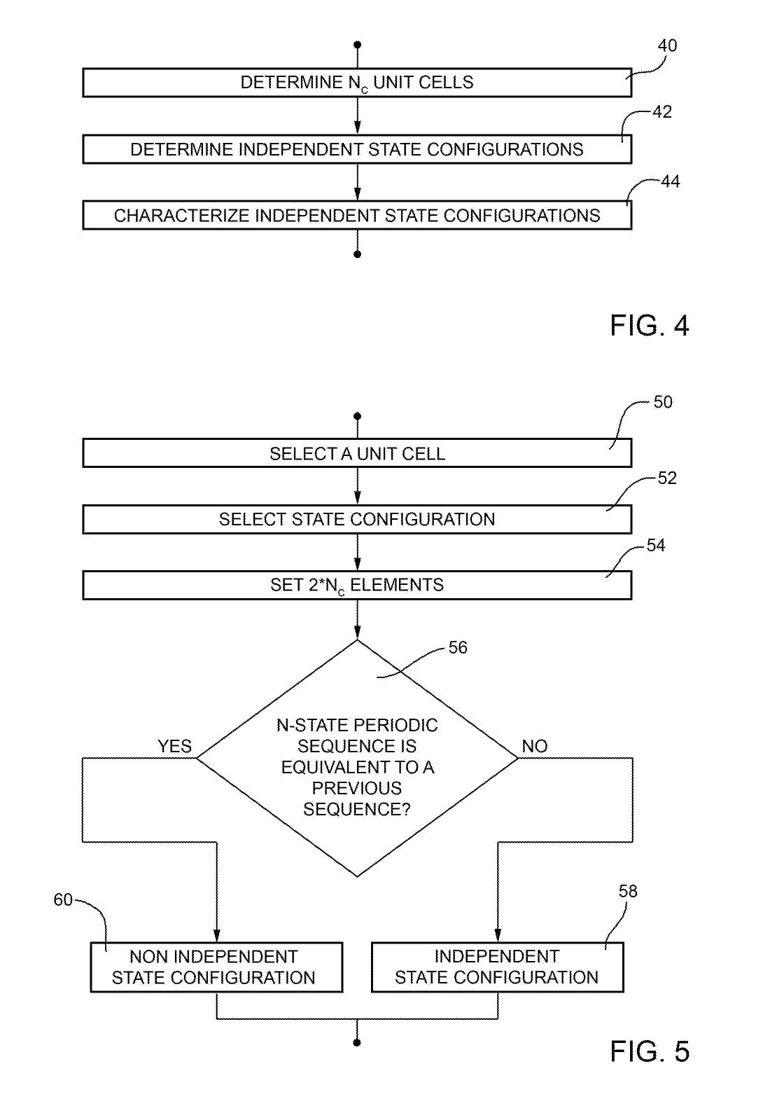

More specifically, as shown in FIG. 4, it is possible to establish (block 40) a number N_{c} of unit cells, each of them being formed by a different number Mᵢ of adjacent elementary cells, which will be referred to in the following as the length Mᵢ of the unit cell. As an example, it is possible to determine N_{c} unit cells, having lengths M respectively equal to 1, 2, . . . , N_{c}.

Then, for each of such determined unit cells, a corresponding number Iᵢ of independent configurations of state is determined (block 42).

More specifically, given a unit cell of length Mᵢ, we determine, among the 2̂Mᵢ possible configurations of state, i.e. among the 2̂Mᵢ possible sets of states formed by the Mᵢ states relevant to the elementary cells forming the given unit cell, the Iᵢ configurations of state which, repeated periodically, generate an independent periodic sequence of states, i.e. a periodic sequence of states which cannot be obtained by a periodic repetition of other configurations of state.

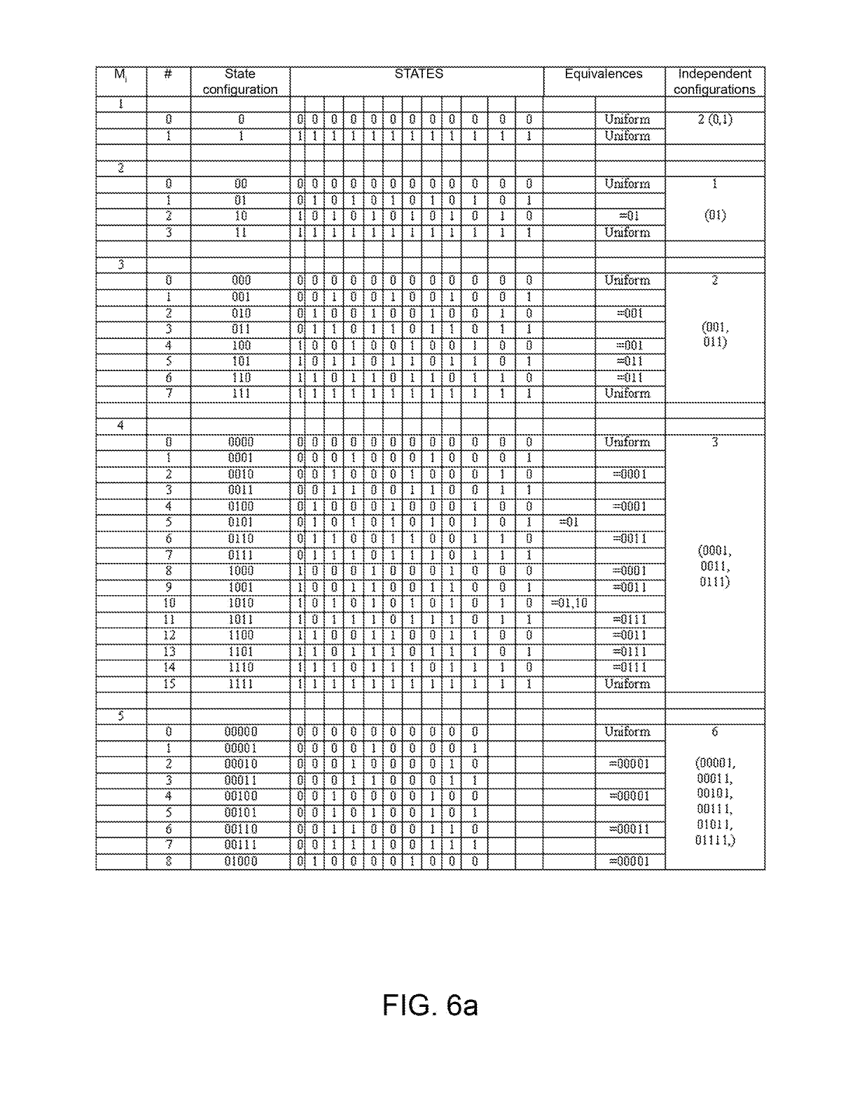

For example, the determination of the independent configuration of states may occur through the execution of the operations shown in FIG. 5.

In particular, subject to the assumption of a vector formed for example by 2*N_{c} elements, it is possible to singularly select (block 50) the unit cells through the operations of which at block 40, starting from the unit cell of length Mᵢ equal to one and finishing with the unit cell with length Mᵢ equal to N_{c}.

In the following, for each selected unit cell, the possible 2̂Mᵢ configurations of state are singularly selected (block 52), and subsequently, for each selected configuration of state, the 2*N_{c} elements of the vector are set (block 54) in such a way to periodically repeat the selected configuration of state. In practice, the first Mᵢ elements of the vector are set in such a way that they contain the selected configuration of state; subsequently the second Mᵢ elements of the vector are set in such a way that they contain the selected configuration of state, and so on, up to the end of the 2*N_{c} elements of the vector. In case 2*N_{c} is not a multiple of the length Mᵢ of the selected unit cell, the last repetition of the selected configuration of state is partial.

Subsequently, it is determined (block 56) if the periodic sequence of states defined by the 2*N_{c} elements of the vector is equivalent to a periodic sequence of states previously defined. In particular, given a first and a second periodic sequence of states, they are equivalent if they are equal, possibly but for a phase shift of the states. Specifically, the first and the second periodic sequences of states are equivalent if the second periodic sequence of states can be obtained shifting by a number z of states (with z positive integer or zero) the first sequence of states, namely through a circular permutation of the first periodic sequence. In other words, employing an index i to indicate the states of the first periodic sequence (with 0≦i≦N−1), the first and the second sequences of states are equivalent if the second periodic sequence of states can be obtained starting from the first periodic sequence of states shifting the states of the first periodic sequence in such a way that the state i is equal to the state(i-z) modulus N, with 0≦i≦N−1.

In the case when the periodic sequence of states defined by the contents of the 2*N_{c} elements of the vector is not equivalent to any previously defined periodic sequence of states (NO output in block 56), the configuration of state is independent (block 58). Vice versa, in the case when the periodic sequence of states defined by the 2*N_{c} elements of the vector is equivalent to at least one previously defined periodic sequence of states (YES output in block 56) the selected configuration of state is not independent (block 60).

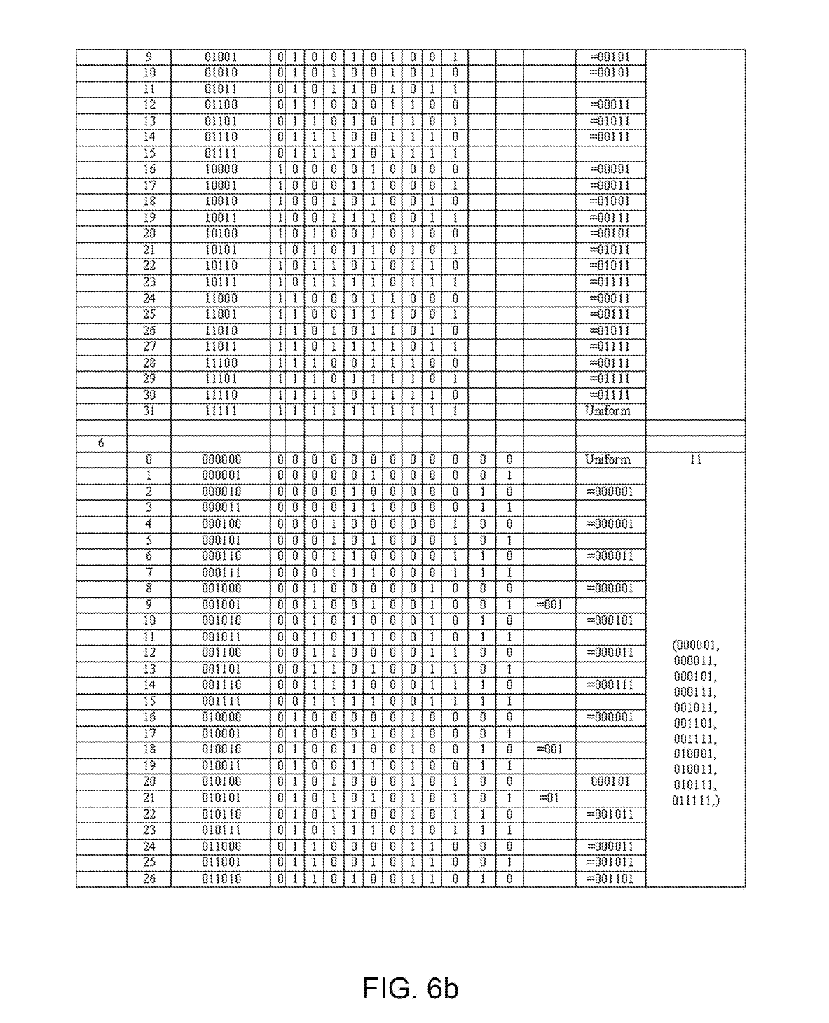

An example of the above described operations is shown in FIGS. 6a-6c, where parts of the same table are reported for the case of six unit cells (N_{c}=6), having lengths Mᵢ comprised between one and six. For each unit cell, 2̂Mᵢ progressive numbers are reported, indicative of possible correspondences of configurations of state; moreover, for each considered configuration of state, there are reported:

a first string of Mᵢ bits, which identifies the considered configuration of state;

a second string of twelve bits, representing the N elements of the vector, as set according to the selection of the considered configuration of state;

a possible first indication of equivalence, which identifies one or more different configurations of state which are equivalent to the considered configuration of state, and which have different lengths with respect to the length of the considered configuration of state; and

a possible second indication of equivalence, which identifies one or more different configurations of state which results to be equivalent to the considered configuration of state, or which identifies a uniformity condition, in case when all the N elements of the vector are equal.

Finally, for every unit cell it is reported the corresponding number Iᵢ of independent configurations of state, as well as the independent configurations of state themselves, represented by the corresponding first strings.

In practice, each unit cell may be associated to a respective number Iᵢ of independent configurations of state. Moreover, the described operations allow determining the overall independent configurations of state associated to the N_{c} unit cells previously determined, by summing the Iᵢ's of the independent configurations of state determined for each unit cell. As an example, relative to the case presented in FIGS. 6a-6c, there are a total of twenty-four independent configurations of state.

Again, referring to FIG. 4, after determining the overall independent configurations of state associated to the N_{c} unit cells previously determined, each independent configuration of state is characterized (block 44).

Specifically, referring to a unit cell whose elementary cells have states corresponding to an independent configuration of state as a patterned cell, for each independent configuration of state the corresponding electromagnetic response is determined, namely an electromagnetic response of the patterned cell. As an example, for each independent configuration of state the dispersion diagram and/or the scattering matrix and/or the transfer function and/or the radiation pattern of the corresponding patterned cell is determined.

In practice, in the present document, reference to a unit cell indicates a set of adjacent elementary cells (non necessarily belonging to the tunable structure 1), irrespective of the states of these elementary cells, and reference to a patterned cell indicates a unit cell (non necessarily belonging to the tunable structure 1) whose elementary cells have certain states; in other words, a reference to a patterned cell implies reference to a correspondent independent configuration of state. Therefore, in the following, patterned cells are also referred through identification of the corresponding independent configuration of state, and consequently through the use of a corresponding binary string. Moreover, in the following it is assumed, without loss of generality, that for every independent configuration of state a corresponding dispersion diagram is determined, namely a diagram providing, for any surface wave and any value of the frequency, the phase shift between the input and output ports of the considered patterned cell. Moreover, for every surface wave and for every frequency considered, the dispersion diagram allows to determine, in a per se known way, if for the considered frequency the surface wave is guided, or it radiates. Again, being the geometrical dimensions of the corresponding patterned unit cell known, and in particular being known a length Len along the principal direction L, it is possible to determine, considering the phase shift, the values of the propagation constants whereby the surface waves pass across the corresponding patterned cell.

The determination of every dispersion diagram is carried out in a per se known way, for example by employing numerical processing techniques, and under the hypothesis that the corresponding patterned cell belongs to an infinitely extended periodic structure, non tunable and obtainable through periodic repetition of the same corresponding patterned cell. In particular, the determination of the dispersion diagrams is carried out through the determination of the eigen-modes of the corresponding patterned cells, and imposing periodic boundary conditions.

In practice, if the control unit 14 controls, through respective command signals, the first and the second transistor 20a, 20b of the elementary cells 16 in such a way that the tunable structure 1 results to be formed by one or more groups of patterned cells, every group being formed by a respective number of identical patterned cells, it is allowed to assume that the previously determined dispersion diagrams faithfully represent the behaviour of the patterned cells. In other words, given a patterned cell belonging to a given group of patterned cells of the tunable structure 1, the corresponding dispersion diagram, determined assuming that the patterned cells belongs to an infinitely extended periodic structure, may be considered as an estimate of the actual response that the given patterned cell exhibits when inserted in the tunable structure 1. Such estimate is as more reliable as higher is the number of the patterned cells forming the group to which the given patterned cell belongs; in particular, if such group results to be formed by three or more patterned cells, it is allowed to equalize such estimate to the actual response provided by the given patterned cell when inserted inside the tunable structure 1.

That being stated, with reference to a patterned cell belonging to the tunable structure 1, the corresponding dispersion diagram provides the phase shifts introduced on the surface waves propagating along the tunable structure 1 by such patterned cell, varying the frequency of the same surface waves. In this case, assuming a generic surface wave propagating along the tunable structure 1, the dispersion diagram provides the phase difference between the phase of the generic surface wave at the output and at the input of such patterned cell.

On the basis of the previous statements, it follows that, if the control unit 14 controls, through the respective control signal, the first and the second transistors 20a, 20b of the elementary cells 16 in such a way that the tunable structure 1 results to be formed by one or more groups of patterned cells, it is possible to determine the response of the tunable structure 1 as a function of the responses of the single patterned cells.

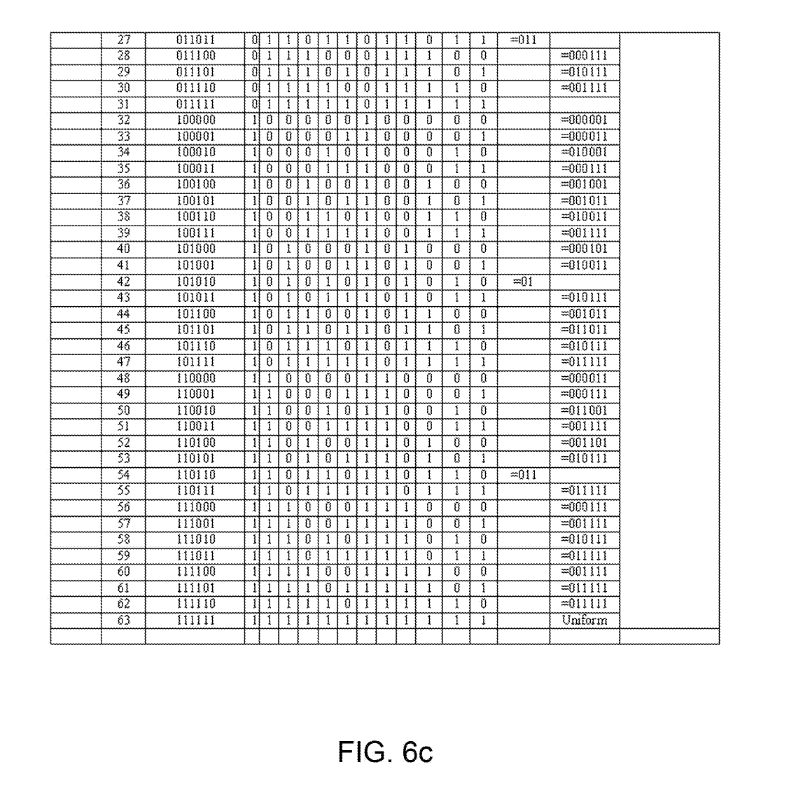

From an operating point of view, if a target tunable structure has to be implemented, starting from the tunable structure 1, namely a tunable structure having a given electromagnetic response, it is possible to perform the operations shown in FIG. 7.

For sake of simplicity, the operations shown in Figure are described under the hypothesis that the dispersion diagrams related to the independent configurations of state refer to the same surface wave, although actually any of them refers, in principle, to an arbitrary number of surface waves. Moreover, without loss of generality, the operations shown in FIG. 7 are relative to the case when the target tunable structure fulfils the function of an antenna, which presents, at a given operational frequency f₀, a target radiation pattern, namely a target response. Therefore, it is assumed, that the dispersion diagrams relative to the independent configurations of state refer to the same surface wave, which at the operational frequency f₀ is not bounded, but it radiates.

Specifically, the target radiation pattern is determined (block 70), and subsequently, starting from the target radiation pattern, a plurality of local phase shifts Δφᵢ are determined (block 72), each of which is associated to a corresponding spatial coordinate. As it is known, the local phase shifts Δφᵢ are the phase shifts a generic excitation signal must take, in correspondence to the points defined by the corresponding spatial coordinates, to obtain the target radiation pattern. The operations in block 72 are known also as synthesis of an antenna.

Subsequently, for each of the independent configurations of state, and therefore for every patterned cell, a corresponding effective phase shift Δφₑ is determined (block 74), as a function of the corresponding dispersion diagram and of the operational frequency f₀.

In the following, for each local phase shift Δφᵢ, a corresponding set of groups of patterned cells is determined (block 76), based on the effective phase shifts Δφₑ and a respective number constraint. Specifically, a number constraint indicates that the corresponding set of groups of patterned cells cannot be formed by groups of patterned cells containing less then Nₜₕ patterned cells.

More specifically, the operations in block 76 aim to determine a set of groups of patterned cells formed by elementary cells such that i) every group is formed by at least Nₜₕ identical patterned cells and ii) the patterned cells globally present in such a set of patterned cells introduce, at the operational frequency f₀, a total effective phase shift Δφ_{ec} as the closest possible to the local phase shift Δ ᵢ. When the number N_{c} of the unit cells, and therefore the number of the patterned cells, increase, a larger number of effective phase shifts A_{T}, are available, in such a way that it is possible to determine sets of groups of patterned cells, whose overall effective phase shifts Δφ_{ec} approximate still better the corresponding local phase shift Δφᵢ.

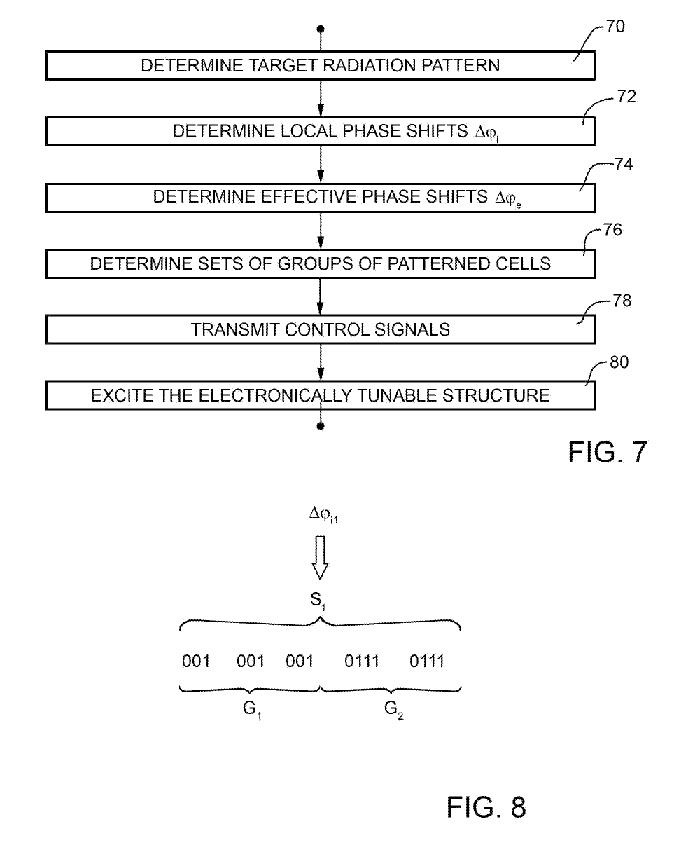

For example, with reference to a generic local phase shift Δφᵢ₁ and to the case when Nₜₕ is equal to two, and assuming that the patterned cell “001” introduces a corresponding effective phase shift of Δφᵢ₁/12, and that the patterned cell “0111” introduces a corresponding effective phase shift of Δφᵢ₁/4, the operations in block 76 may lead to the situation depicted in FIG. 8, where the bits “0” and “1” indicate in a symbolic way corresponding elementary cells, controlled in such a way that the respective patch are alternatively connected to the ground plane (bit “0”) or floating (bit “1”).

Specifically, the set of groups of patterned cells relative to the local phase shift Δφᵢ₁, indicated as S₁, is formed by a first and by a second group, indicated as G₁ and G₂ respectively.

The first group G₁ is formed on its turn by three equal patterned cells “001”, each of them being formed by a first, a second and a third elementary cell. The first, the second and the third elementary cell comprise a first, a second and a third patch respectively; moreover, the first and the second patch are connected to the ground plane, while the third patch is floating. Conversely, the second group G₂ is formed by two equal patterned cells “0111”, each of them being formed by a fourth, a fifth, a sixth and a seventh elementary cell. The fourth, the fifth, the sixth and the seventh elementary cell comprise respectively a fourth, a fifth, a sixth and a seventh patch. Moreover, the fourth patch is connected to the ground plane, while the fourth, the fifth, the sixth and the seventh patches are floating.

Subsequently, the control unit 14 transmits (block 78) to the first and to the second transistors 20a, 20b of the elementary cells 16 control signals such that the tunable structure 1 results to be formed by sets of groups of patterned cells which correspond to the local phase shifts Δφᵢ.

For example, assuming that the control unit 14 controls the first and the second transistors 20a, 20b of the elementary cells 16 of the tunable structure 1 through digital command signals, it is possible to represent the set of N command signals by a command string formed by N bits. Therefore, still with reference to FIG. 8, a possible command string, relative to a portion of the tunable structure 1, is given by 001 001 001 0111 0111. In such way, this tunable structure 1 results to be furthermore formed by the set S₁ of groups of patterned cells previously determined.

When the surface wave source 12 excites (block 80) the surface wave at the operating frequency f₀, the tunable structure 1 works therefore as an antenna, and exhibits a radiation pattern that approximates the target radiation pattern.

As for the terminology, in the case when the control signals are such that the tunable structure 1 results to be formed by all identical patterned cells, the tunable structure 1 is said periodic, otherwise the tunable structure 1 is said quasi periodic.

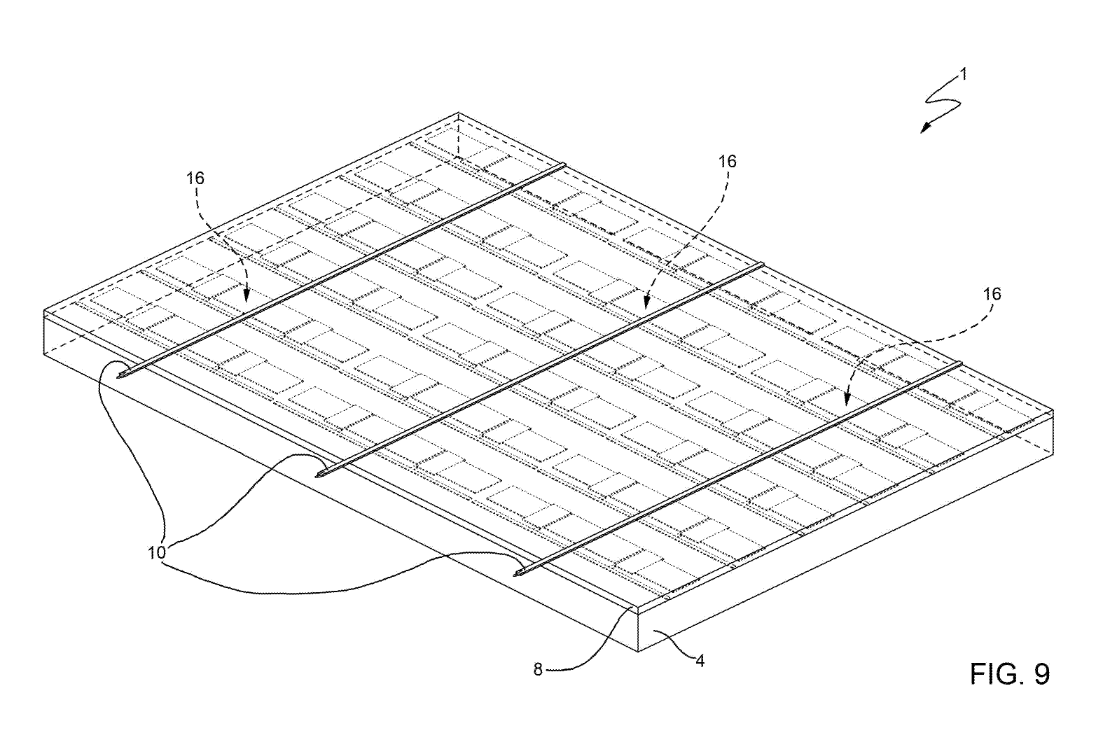

As shown in FIG. 9, it is however possible that the elementary cells 1 are not aligned, but rather are arranged in such a way to form a planar array of dimensions K×Nₖ, with K≧2 (in the example shown in FIG. 9, it is K=3). In that case, the tunable structure 1 includes K microstrip lines, indicated as 10; moreover, to each microstrip line 10 is associated a number Nₖ of elementary cells, indicated as 16 and arranged below the respective microstrip line. The command unit 14 may therefore transmit control signals such that, given a generic microstrip line 10, the Nₖ elementary cells 16 associated to the generic microstrip line 10 define patterned cells which correspond to respective independent configurations of state. As previously described, given the same microstrip line 10, the associated patterned cells may be different; moreover, the patterned cells relative to a first microstrip line may be different from the patterned cells associated to a second microstrip line, possibly adjacent to the first microstrip line.

The advantages the present method allows obtaining clearly appear from the previous discussion. In particular, the present method allows implementing tunable structures having a predetermined electromagnetic response, based on a reduced number of patterned cells, previously characterized and arranged in periodic or quasi periodic configuration. Since the patterned cells are formed, on their turn, by a reduced number of elementary cells, their characterization can be done in a non excessively long time.

Finally, it is apparent that modifications and changes can be brought to the present method and to the tunable structure 1, still remaining in the scope of the present invention.

For example, as previously mentioned, the tunable structure 1 may act as a filter instead of as an antenna; again, the tunable structure 1 may act as a delay line or a high impedance surface. In particular, in the case where the tunable structure 1 acts as a filter, it is possible to determine the dispersion diagrams with particular reference to the fundamental transverse electromagnetic (TEM) mode, which, as it is known, cannot radiate and has zero cut-off frequency. Conversely, and again referring to the case when the tunable structure 1 acts as an antenna, it is possible to neglect the TEM mode and to determine the dispersion diagrams relative only to the higher order modes, which, for particular frequencies, can radiate.

It is moreover possible that the tunable structure 1 be different with respect to what described here. For example the microstrip line 10 may be missing, in which case the tunable structure 1 will not support the TEM mode. Furthermore, it is possible that the elementary cells be different from what described here; similarly, it is possible that any elementary cell 16 interacts with the incident electromagnetic field in a way that may be expressed in terms of non binary states. For example, the states can be expressed in form of integer numbers; possibly, the states may be continuous, hence expressed as real numbers.

Again, concerning the number constraints, it is possible that different independent configurations of state are associated to different number constraints on the patterned cells.

Finally, with particular reference to the operations in FIG. 7, since the sets of groups of patterned cells occupy a space (depending on the dimensions and on the distances between the elementary cells) that cannot be always neglected, in a per se known way it is possible to apply correction factors to the local phase shifts Δφᵢ and carry out the operations in block 76 on the local phase shifts obtained in this way.

The present invention is a result of a work supported by a Marie Curie International Outgoing Fellowship within the 7^{th} European Community Framework Programme([FP7/2007-2013]) project n^{°}PIOF-GA-2008-221403.

1. A method for implementing an electronically tunable structure, said electronically tunable structure comprising:
a plurality of elementary cells, said elementary cells being configured to interact with the same electromagnetic field;
a control unit and a plurality of electronic control devices, each electronic control device being connected to said control unit and to a respective elementary cell, said control unit being configured to provide each electronic control device with a corresponding control signal, each electronic control device being controllable by the respective control signal so as to vary a state of the corresponding elementary cell, said state being associated to an electrical characteristic of the corresponding elementary cell;
characterised by further comprising the steps of:
transmitting to said electronic control devices, from said control unit, control signals such as to define at least one group of identical patterned cells, each patterned cell being formed by a respective number of adjacent elementary cells, the states of which define a respective predetermined state configuration, so that the states of the elementary cells of said at least one group define a periodical sequence of states.

2. The method according to claim 1, wherein a characterised electromagnetic response of the corresponding patterned cell is associated to said predetermined state configuration.

3. A method according to claim 1, further comprising the steps of:
determining a plurality of predetermined state configurations relating to corresponding patterned cells; and
characterising each predetermined state configuration by determining an electromagnetic response of the corresponding patterned cell.

4. The method according to claim 3, wherein said predetermined state configurations are independent of one another, each predetermined state configuration being formed by a sequence of states such that the periodical repetition of said sequence of states generates a periodical sequence of states that cannot be obtained by the circular permutation of periodical sequences obtained by the periodical repetition of different sequences of states.

5. The method according to claim 3, wherein said step of characterising comprises estimating said electromagnetic response in the hypothesis that said corresponding patterned cell is part of an infinitely extended periodical structure.

6. The method according to claim 3, further comprising the steps of:
determining a plurality of local offsets as a function of a target electromagnetic response relating to said plurality of elementary cells and to an operative frequency;
determining, for each predetermined state configuration, a corresponding actual offset, on the basis of the electromagnetic response of the corresponding patterned cell and of the operative frequency;
determining, for each local offset, a corresponding set of groups of patterned cells, as a function of the determined actual offsets;
and wherein said step of transmitting control signals comprises transmitting control signals such as to define, in said plurality of elementary cells, said determined sets of groups of patterned cells.

7. The method according to claim 1, wherein said electronically tunable structure comprises a ground plane, and wherein each elementary cell comprises a respective patch of conductor; each of said electronic control devices being configured to vary the state of the corresponding elementary cell between a first state, in which the patch of said corresponding elementary cell is electrically connected to the ground plane, and a second state, in which the patch of said corresponding elementary cell is floating with respect to the ground plane.

8. The method according to claim 1, further comprising the step of:
exciting said plurality of elementary cells by means of said same electromagnetic signal.

9. An electronically tunable structure comprising:
a plurality of elementary cells of conductor configured to interact with the same electromagnetic field;
a control unit and a plurality of electronic control devices, each electronic control device being connected to said control unit and to a respective elementary cell, said control unit being configured to provide each electronic control device with a corresponding control signal, each electronic control device being controllable by the respective control signal so as to vary a state of the corresponding elementary cell, said state being associated to an electrical characteristic of the corresponding elementary cell;
characterised in that said control unit is configured to transmit to said electronic control devices control signals such as to define at least one group of identical patterned cells, each patterned cell being formed by a respective number of adjacent elementary cells, the states of which define a respective predetermined state configuration, so that the states of the elementary cells of said at least one group define a periodical sequence of states.

10. The electronically tunable structure according to claim 9, wherein a characterised electromagnetic response of a corresponding patterned cell is associated to each of said predetermined state configurations.

11. The electronically tunable structure according to claim 10, wherein said predetermined state configurations are independent of one another, each predetermined state configuration being formed by a sequence of states such that the periodical repetition of said sequence of states generates a periodical sequence of states that cannot be obtained by the circular permutation of periodical sequences obtained by the periodical repetition of different sequences of states.

12. The electronically tunable structure according to claim 10, wherein the electromagnetic response of each of said predetermined state configurations defines a corresponding actual offset relating to an operative frequency; and wherein said control unit is configured to transmit to said electronic control devices control signals such as to define sets of groups of identical patterned cells, said sets of groups of identical patterned cells being adapted to generate, at said operative frequency, respective local offsets, so that, in use, said plurality of elementary cells generates, at said operative frequency, a target electromagnetic response.

13. The electronically tunable structure according to claim 9, further comprising a ground plane, and wherein each elementary cell comprises a respective patch of conductor; each of said electronic control devices being configured to vary the state of the corresponding elementary cell between a first state, in which the patch of said corresponding elementary cell is electrically connected to the ground plane, and a second state, in which the patch of said corresponding elementary cell is floating with respect to the ground plane.

14. An electronic device comprising the electronically tunable structure according to claim 9, and also a surface wave generator configured to generate at least one surface wave interacting with said plurality of elementary cells.

15. The electronic device according to claim 14, further comprising a microstrip coupled electromagnetically to said plurality of elementary cells, so that said plurality of elementary cells and said microstrip exhibit an electromagnetic TEM mode.

16. An antenna comprising an electronic device according to claim 14.

17. A filter comprising the electronically tunable structure according to claim 9.
